(19) United States
(12) Patent Application Publication
(10) Pub. No.: US 2002/0010634 A1
(43) Pub. Date: Jan. 24, 2002

(54) Reverse logistics processing

(76) Inventors: Anthony Roman, Newport Beach, CA (US); Joseph Morin, Irvine, CA (US)

Correspondence Address: Steven E. Shapiro, Esq., MITCHELL, SILBERBERG & KNUPP LLP, 11377 West Olympic Boulevard, Los Angeles, CA, 90064, US

(21) Appl. No.: 09/733,236

(22) Filed: Dec. 8, 2000

Related U.S. Application Data
(60) Provisional application No. 60/171,027, filed on Dec. 15, 1999.

(51) Int. Cl. G06F 17/60

(52) U.S. Cl. 705/26; 705/14

(57) ABSTRACT

Provided is a technique for use in connection with the return of an item having been previously purchased by a consumer from a seller. Initially, a request to return the purchased item is received. In response, a replacement product is selected by matching a predefined database of selling options and the replacement product is offered to the consumer. The request is then processed, and if the consumer has elected to obtain the replacement product, a credit is issued against the cost of the replacement product.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure, as it appears in the Patent and Trademark Office patent files or records, but otherwise reserves all copyright and trade dress rights whatsoever.

### BACKGROUND OF THE INVENTION

1. Field of the Invention

The present invention relates generally to returns processing and returns disposition including resale of product returns via auction over the Internet.

2. Description of Related Art

Competition for e-commerce revenue among e-tailers is fierce, and competitors are becoming both more numerous and more sophisticated. As a result, e-tailers are under increasing pressure to quickly identify and implement any competitive advantage possible.

In traditional retail venues innovative and exceptional customer service has proven to be a significant competitive advantage. Hassle-free customer service policies are successful tools necessary to maintain customer loyalty, and one of the most prominent of these tools is a liberal return policy on purchased items. It is a natural progression in the development of the e-commnerce industry that Internet sales entities will be forced to offer customer-friendly return policies.

To date the primary focus in the development of e-commerce has been on selling goods and services at lower than normal costs. This strategy forces e-tailers to work on razor thin margins, and the only way to achieve these margins is to lower overhead costs dramatically. Thus, most e-tailers are struggling with issues associated with Internet returns, as handling returned products adds a level of complexity and costs that are difficult to manage.

Returns processing is somewhat of an “invisible” market in that in traditional retail venues, returns departments are already standard and customers come into a retail store to return items. Retail return rates range from 10% -40% of sales, and are handled within the retail store. On the Internet return rates are slightly lower today. However, in many cases the physical ability to handle the returns does not exist, thus making the returned products problem more visible. Online return rates will grow as consumers become more comfortable with the online shopping experience, and subsequently more demanding for traditional return policies.

In 1999, a considerable number of business to consumer e-commerce transactions in were conducted over the Internet. This figure is expected to continue increase for years to come. It is anticipated that product returns grow from 18 million units in 1999 to over 200 millions units by 2003. This will create a substantial opportunity for return product solution providers.

Research from Jupiter Communications indicates that 80% of all e-consumers state price as their number one reason to shop online. According to Internet statistics, repeat customers shopping for discounted merchandise at bargain e-tail sites accounted for approximately 77% of all purchases. In addition, the enormous success of sites such as Priceline.com, Buy.com and eBay, are evidence that consumer demand for “Internet bargains” is strong and activity is accelerating aggressively. Currently, the majority of e-tailers and retailers are using “B Stock” resellers and liquidators to sell a portion of their returned products at discount prices (an average of $0.17 on the dollar) through conventional liquidation methods.

Those e-tailers that lack the necessary infrastructure to effectively manage the product returns process will suffer a noticeable downturn in customer satisfaction and customer retention levels as e-commerce escalates into the mass market. These e-tailers will also experience reduced margins due to the high costs of receiving, handling, storing, inventorying, and disposing of returned goods as well as the depletion of the re-sale value of saleable returned goods due to the multi-movement of merchandise throughout the returns channel. Additionally, the distraction of handling returned merchandise causes a measurable allocation of time, personnel and resources away from the e-tailers primary business thrust of selling merchandise and acquiring customers.

### DETAILED DESCRIPTION OF THE INVENTION

Throughout this description, the preferred embodiment and examples shown should be considered as exemplars, rather than limitations on the apparatus and methods of the present invention.

The previously described e-commerce trends have presented an opportunity to ClickReturns.com. Using a method for an intelligent Internet enabled reverse logistics processing system using alternative methods of disposition and on-line suggestive up-selling techniques, ClickReturns.com offers a better solution to address the growing problem of processing returns online.

In the intelligent Internet enabled reverse logistics processing system using alternative methods of disposition and on-line suggestive up selling techniques, as the consumer prepares to return an item, he/she clicks on the “Return” or “Customer Service” selection to find the ClickReturns.com icon (powered by ClickReturns.com). The system then transfers the consumer into the ClickReturns.com environment.

The consumer is then asked a series of questions about the return. Information such as receipt number, consumer's name, phone number, description of the product being returned matching original transaction record collected from step above, condition of the product, such as original packaging and working condition.

The ClickReturns.com system automatically analyzes the submitted return for fraud and abuse against a proprietary database. The initial category of fraud analyzed is frequency or abuse of an e-tailers established parameters within a specified time period. Other types of fraud are also analyzed such as dummy shipping addresses, and identifying consumers who return with the intent of repurchasing the same item at a discount at a later date.

The ClickReturns.com system then provides on-line suggestive up-selling techniques custom to the e-tailers' requests, matching a predefined intelligent database of up-selling sales options. While a consumer is processing a return, and before the transaction is complete, ClickReturns.com will immediately offer a similar replacement product for purchase or exchange from the originating e-tailer. If interested, the customer will be linked to the targeted item for exchange transaction. If the options are amicable to the consumer, then a credit is issued against the purchase of new product. If the up-selling techniques are not successful then a returns approval will be granted by the system.

The replacement product will be offered either as a pre-approved exchange or purchase. The inventors believe that such pre-approved purchases will increase impulse e-tail purchases. If the customer utilizes the pre-approved purchase credit, the return will be suspended and the purchase placed ‘in escrow’ until the returned item is received and the return transaction approved.

The system then provides instructions for shipping the product back to the ClickReturns.com processing center. A Returns Material Authorization (RMA) number is issued to enable on-line tracking of both the refund and inventory. If the consumer agrees to return the product within a specified period of time, and assuming it passes inspection, in most cases, ClickReturms.com will pay the shipping costs.

The consumer is then prompted to print a packing slip and receipt copy for their records. This packing slip includes the RMA number; return address of the consumer and the shipping address for the ClickReturns.com processing center. The consumer simply affixes this to the package of the returned product and leaves it for the shipper (e.g., US Postal Service) to pick up at the scheduled time, or deposits it in the various carriers' collection sites. The consumer is then advised that a refund or exchange transaction will be completed once the product is received and passes inspection.

The returned product is delivered to the ClickReturns.com processing center and inspected for any obvious package damage caused during shipment. The receiving clerk tracks the return on a computer system via RMA number. Additionally, a digital photo image is preferably automatically attached to the returns database record for this RMA and used for claims against the shipper.

After the returned product packaging is checked for damage, the product itself is inspected. The product is certified to be functional, operational and complete with accessories (if any), power cords (if any), and documentation (if any). Another digital photo image is preferably attached to the returns database record for this RMA. The product is then verified against the pre-authorized acceptance policy and the e-tailer is notified via the Internet or direct connection between the e-tailer and ClickReturns.com.

If the product is returned damaged beyond manufacturer specifications, the consumer is notified and the product returned to them if they wish. If the returned product does not meet the pre-authorized metrics but is not damaged, the e-tailer is automatically sent the photo image and a request for return authorization.

If the returned product is of acceptable quality, then ClickReturns.com preferably disposes of the product in accordance with the retailer's preference. In a preferred embodiment, ClickReturns.com offers the returned product for sale via affiliate e-auction web sites, sharing the income with the retailer.

The following chart details aspects of the method and system of the invention.

| Phase | Description | From | To |
|---|---|---|---|
| 1 | Return process is initiated | e-Returner | e-Tailer |
| | Authorization of return | e-Tailer | e-Returner |
| | Request for shipping/post- | e-Tailer | Shipping |
| | age code/certificate | | |
| | Notification of shipping/ | Shipping | e-Tailer |
| | postage code/certificate | | |
| | Notification of return | e-Tailer | ClickReturns.com |
| | Notification of return | ClickReturns.com | Warehouse-In |
| | Physical shipment of | e-Returner | Warehouse-In |
| | product | | |
| 2 | Physical receipt of product | e-Returner | Warehouse-In |
| | Notification of physical | Warehouse-In | ClickReturns.com |
| | receipt of product and | | |
| | condition | | |
| | Notification of physical | ClickReturns.com | e-Tailer |
| | receipt of product and | | |
| | condition | | |
| | Issuance of credit for | e-Tailer | e-Returner |
| | physically returned product | | |
| | Notification of physical | ClickReturns.com | e-Returner |
| | receipt of product and | | |
| | condition | | |
| | Notification of physical | ClickReturns.com | Shipping |
| | receipt of product | | |
| | Storage request for returned | Warehouse-In | Warehouse- |
| | product | | Store |
| | Notification of returned | Warehouse- | ClickReturns.com |
| | product storage information | Store | |
| 3 | E-TAILER: Notification of | e-Tailer | ClickReturns.com |
| | what action to take on | | |
| | return | | |
| 4a | DISTRIBUTOR: Notifi- | ClickReturns.com | Distributor |
| | cation of return | | |
| | DISTRIBUTOR: Notifi- | Distributor | ClickReturns.com |
| | cation of what action to | | |
| | take on return | | |
| 5a | MANUFACTURER: Noti- | ClickReturns.com | Manufacturer |
| | fication of return | | |
| | MANUFACTURER: Noti- | Manufacturer | ClickReturns.com |
| | fication of what action to | | |
| | take on return | | |
| 4b/ | AUCTION: Notification of | ClickReturns.com | e-Auction |
| 5b | return | | |
| | AUCTION: Notification of | e-Auction | ClickReturns.com |
| | bid | | |
| | AUCTION: Verify credit | ClickReturns.com | Clearing |
| | card | | House |
| 6 | AUCTION: Process pur- | Clearing House | ClickReturns.com |
| | chase to credit card | | |
| 7 | AUCTION: Notification of | ClickReturns.com | e-Auction |
| | declined credit card | | |
| | AUCTION: Notification of | ClickReturns.com | e-Buyer |
| | declined credit card | | |
| | AUCTION: Notification of | e-Auction | ClickReturns.com |
| | buyer | | |
| 8 | ALL: Notification to ship | ClickReturns.com | Warehouse- |
| | product | | Store |
| | ALL: Notification of | Warehouse- | Warehouse- |
| | shipment request | Store | Out |
| | ALL: Request for shipping/ | Warehouse-Out | Shipping |
| | postage code/certificate | | |
| | ALL: Notification of ship- | Shipping | Warehouse- |
| | ping/postage code/ | | Out |
| | certificate | | |
| | ALL: Notification of | Warehouse-Out | ClickReturns.com |
| | shipment | | |
| | ALL: Notification of return | ClickReturns.com | e-Seller |
| | sale | | |
| | ALL: Physical shipment of | Warehouse-Out | e-Buyer |
| | product | | |
| 9 | ALL: Notification of | Warehouse-Out | e-Buyer |
| | product shipment | | |

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

It is claimed:

1. A method of processing a product by a customer to a retailer through an agent, the method comprising the steps of:
(a) the customer communicating to the retailer's e-commerce site a desire to return the product;
(b) the agent's site obtaining information about the desired product return from the customer;
(c) the agent's site analyzing the information for fraud and abuse;
(d) the agent's site causing the customer's return request to be refused if fraudulent or abusive;
(e) offering the customer a replacement for the product;
(f) the agent's site providing instructions to the customer for shipping the product back to the agent;
(g) the agent receiving the returned product;
(h) the agent inspecting the returned product for shipping damage;
(i) the agent inspecting the product for functionality, damage and completeness;
(j) the agent verifying the returned product against the retailer's acceptance policy;
(k) the agent notifying the retailer of the return;
(l) the agent disposing of the returned product.

2. The method of processing a product by a customer to a retailer through an agent of claim 1 further comprising the agent's site suggesting up-selling options to the customer.

3. The method of processing a product by a customer to a retailer through an agent of claim 1 wherein the replacement comprises a pre-approved exchange.

4. The method of processing a product by a customer to a retailer through an agent of claim 1 wherein the replacement comprises a credit with the retailer.
